(19) United States
(12) Patent Application Publication
(10) Pub. No.: US 2025/0386922 A1
(43) Pub. Date: Dec. 25, 2025

(54) Holding Apparatus for Holding an Object on an Assembly

(71) Applicant: Fidlock GmbH, Hannover (DE)

(72) Inventors: Michael Schröder, Bad Wildungen (DE); Artur Siebert, Hannover (DE); Breido Botkus, Hannover (DE); Joachim Fiedler, Hannover (DE)

(21) Appl. No.: 18/877,303

(22) PCT Filed: Jun. 23, 2023
(86) PCT No.: PCT/EP2023/067150

§ 371 Date: Dec. 20, 2024

(30) Foreign Application Priority Data
Jun. 27, 2022 (DE) 10 2022 206 462.3

(51) Int. Cl. A45F 5/00; A45F 5/02

(52) U.S. Cl. CPC A45F 5/1575; A45F 5/021

(57) ABSTRACT

A holding apparatus for holding an object on an assembly comprises a first closure part that has an insertion opening and a displacement portion adjoining the insertion opening, and a second closure part that comprises an engagement element. In order to close the holding apparatus for holding the object on the assembly, the engagement element of the second closure part can be inserted into the insertion opening of the first closure part and be displaced along the displacement direction out of the region of the insertion opening into the displacement portion, such that in a holding position the engagement element engages in the displacement portion and as a result the first closure part and the second closure part are held against one another. The first closure part comprises a first magnet element and the second closure part comprises a second magnet element.

### CROSS-REFERENCE TO RELATED APPLICATIONS

This application is the United States national phase of International Patent Application No. PCT/EP2023/067150, filed on Jun. 23, 2023, and claims priority to German Patent Application No. 10 2022 206 462.3, filed on Jun. 27, 2022, the disclosures of which are hereby incorporated by reference in their entireties.

### BACKGROUND

### Technical Field

The proposed solution relates to a holding apparatus for holding an object on an assembly.

### Technical Considerations

An existing holding apparatus, as described in U.S. Pat. No. 10,271,634, is configured as toolholder and comprises a closure part on which a displacement portion is formed, in which it is possible to insert a further closure part with a spherical engagement element. In an end position, the engagement element can be tilted about 90°, such that the engagement element can be brought into a suspended position in the end position.

### SUMMARY

It is an object underlying the proposed solution to provide a holding apparatus for holding an object on an assembly, which is easy and comfortable for a user to handle, even in an industrial application, and in the process can provide reliable holding of the object on the assembly in a holding position.

This object is achieved by a holding apparatus having features as described herein.

According to a non-limiting embodiment, provided is a holding apparatus having a first closure part, the first closure part comprising a first magnet element, and a second closure part comprises a second magnet element. The first magnet element and the second magnet element interact in a magnetically attracting manner for assisting the insertion of the engagement element into the insertion opening. The first closure part comprises a housing that is formed by at least one housing part, and a blocking element that is arranged displaceably on the housing and is intended for blocking the engagement element in the holding position.

The holding apparatus according to the present disclosure serves for holding an object on an assembly, for example for holding a tool on an associated carrying apparatus, for example a tool belt. Thus, for example a tool, for example a hammer or an electromotive tool such as a cordless screwdriver or the like, can for example be connected to the associated carrying apparatus for example via the holding apparatus, such that the tool is held securely and reliably on the carrying apparatus in a holding position.

For a reliable hold and furthermore for a simple, comfortable connection of the object to the assembly, a first closure part of the holding apparatus comprises an insertion opening and a displacement portion that adjoins the insertion opening. The displacement portion comprises two edge portions extending along a displacement direction. In contrast, a second closure part comprises an engagement element. In order to close the holding apparatus, the head of the engagement element can be inserted into the insertion opening of the first closure part, in order to then be inserted with the head along the displacement direction out of the region of the insertion opening into the displacement portion, and thus to establish a connection between the closure parts. In a holding position, the engagement element engages in particular in a form-fitting manner in the displacement portion, and thus establishes a connection between the closure parts.

The edge portions of the displacement portion can extend in parallel with one another along the displacement direction or can be oriented at a (small) angle of at most 15° relative to the displacement direction. If the edge portions are oriented at an angle to the displacement direction, then the edge portions extend towards one another in the displacement direction, such that a slot formed between the edge portions tapers in the displacement direction.

With respect to its extension length along the displacement direction, the displacement portion can be configured to be longer than it is wide, preferably more than twice as long. In general, the displacement portion is configured to be of such a length that the engagement element can be pushed out of the insertion opening into the displacement portion and be pushed in the displacement portion as far as the holding position, wherein in the case of a displacement the head engages behind the edge portions and the shank extends through between the edge portions, such that the engagement element, in the event of a displacement, is already held on the first closure part in a form-fitting manner along a direction perpendicular to the displacement direction and a transverse direction. In this case, the transverse direction corresponds to the direction along which the edge portions are spaced apart from one another.

Since, upon interconnection of the closure parts, the engagement element is pushed out of the insertion opening into the displacement portion and is engaged with the displacement portion in the holding position, a more reliable connection between the closure parts can be achieved, wherein the engagement element is held securely and reliably in the displacement portion by the blocking element and cannot readily slide out of the region of the displacement portion.

The displacement path that the edge portions define by the longitudinal extension can in particular be greater than an undercut depth of the second closure part, preferably significantly (multiple times) greater. The undercut depth is defined by the extended breadth of the head compared with the shank. The head is dimensioned to be larger than the shank, in particular having a larger diameter with respect to the transverse direction, such that the head engages behind the edge portions during displacement and in the holding position, and the shank extends through between the edge portions.

In non-limiting embodiments, the holding apparatus is configured as a magnetic holding apparatus in that each closure part comprises a magnet element. The magnet elements of the closure parts interact in a magnetically attracting manner, such that the attachment of the closure parts to one another is magnetically assisted. Due to the magnetic assistance of the magnet elements, when the closure parts approach one another the engagement element comes into engagement with the insertion opening largely automatically, such that the closure parts are preferably slightly, advantageously largely, automatic and the closing of the closure device is thus particularly easy and comfortable for a user.

The magnet elements can for example each be configured by a permanent magnet, wherein when the closure parts are attached to one another the permanent magnets oppose one another with opposite poles and thus magnetically attract one another. However, the magnet elements can also be configured on the one hand by a permanent magnet and on the other hand by a magnetic armature, for example consisting of a ferromagnetic material and thus configured as a passively magnetic element.

Furthermore, the first closure part comprises a housing that is formed by at least one housing part, and a blocking element that is arranged displaceably on the housing and is intended for blocking the engagement element in the holding position. The position the engagement element is thus additionally secured by the blocking element when the engagement element is inserted into the displacement portion in order to interconnect the closure parts. The blocking element is in particular configured, in a blocking position, to block a movement of the engagement element out of the holding position counter to the displacement direction, such that the engagement element cannot be moved out of the displacement portion. The engagement element is thus blocked in the displacement portion and thus relative to the first closure part, in the holding position, such that the engagement element cannot be readily moved out of the displacement portion, in any case not without overcoming the blocking effect of the blocking element, and thus the second closure part cannot be separated from the first closure part. Rather, in order to separate the closure parts from one another the blocking effect must be overcome, such that the engagement element can be displaced counter to the displacement direction, in the displacement portion, and moved out of the displacement portion.

The housing of the first closure part preferably also forms the displacement portion and also the insertion opening.

The first closure part can for example be associated with the assembly, for example a carrying apparatus, for example a tool belt. In contrast, the second closure part can for example be associated with the object, for example a tool. Thus, by interconnecting the closure parts, a connection of the object to the assembly, for example a tool to an associated carrying apparatus, can be established.

Alternatively, however, in a kinematic reversal, it is also possible for the first closure part to be associated with the object, for example a tool, and the second closure part to be associated with the assembly, for example a carrying apparatus, for example a tool belt.

In a non-limiting embodiment, the engagement element can be inserted into the insertion opening along a closure direction, wherein the displacement direction is directed transversely to the closure direction. The insertion opening has a larger clear width compared with the displacement portion, and can be configured for example as a round, for example circular, opening. The insertion opening can for example be funnel-shaped, such that a guide for guiding the engagement element towards the inlet of the displacement portion is also provided in the region of the insertion opening, when the closure parts are attached to one another for closing the holding apparatus.

In a non-limiting embodiment, the first magnet element is arranged in the region of the insertion opening, on the first closure part. The first magnet element can for example be arranged on a bottom, which defines the insertion opening in the closure direction and with which the head of the engagement element comes into contact when the closure parts are attached to one another. In this case, the first magnet element is preferably arranged in front of the displacement portion, viewed along the displacement direction, and somewhat outside the region of the displacement portion.

In this way, the first magnet element is configured for drawing the head of the engagement element into engagement with the insertion opening, for closing the holding apparatus. Since the first magnet element is arranged in the region of the insertion opening, for example on a boundary wall of the insertion opening, the first magnet element, by interaction with the second magnet element, for example on the engagement element of the second closure part, assists the insertion of the engagement element into the insertion opening, in that the head of the engagement element is pulled into the insertion opening by the magnetic attractive force. The magnetic attraction provided by the magnet elements thus serves in particular for facilitating the attachment of the closure parts to one another.

The firm hold of the closure parts on one another is then established-after insertion of the engagement element into the insertion opening for closing the holding apparatus-in that the head of the engagement element is displaced in the displacement direction, out of the region of the insertion opening and into the displacement portion. Whereas upon insertion of the engagement element into the insertion opening the magnet elements are moved towards one another, upon displacement of the engagement element into the displacement portion, in one embodiment the second magnet element of the second closure part is removed from the first magnet element of the first closure part, such that the magnetic attraction weakens. Thus, in the holding position, the hold is provided primarily by the engagement of the engagement element in the displacement portion.

In a non-limiting embodiment, the head of the engagement element can for example be configured to be rotationally symmetrical (with respect to the closure direction). The head of the engagement element is thus configured to be rotationally symmetrical about an axis of rotation facing along the closure direction. This has the advantage that the second closure part can be attached to the first closure part in principle in any rotational position (about the axis of rotation), and can also be turned relative to the first closure part in the holding position. An object held by the holding apparatus can thus be positioned in a variable manner on the associated assembly, in the case of a reliable hold established via the holding apparatus.

The second magnet element can in particular be arranged on the engagement element, preferably inside the head of the engagement element. In this case, the second magnet element can for example be configured cylindrically and for example be arranged concentrically with respect to the axis of rotational symmetry of the head of the engagement element. A magnetic attraction is thus provided directly on the engagement element, such that the engagement element can be pulled directly into engagement with the insertion opening by the magnetic interaction of the magnet elements upon closure of the holding apparatus.

In a non-limiting embodiment, the head of the engagement element is formed for example by a spherical head. The head of the engagement element thus has a spherical shape at least in portions, the engagement of which in the displacement portion establishes a hold of the closure parts on one another in the holding position. The spherical embodiment of the engagement element has the further advantage that the engagement element can optionally pivot relative to the first closure part, in a certain angle range, in a plane transverse to the displacement direction, and thus the object can assume a flexibly variable position on the associated assembly.

The displacement portion is delimited by two edge portions. The edge portions extend for example along the displacement direction and preferably extend in parallel with one another at least in portions, but can also extend at a certain (small) angle relative to one another. The edge portions form a slot between them, through which the engagement element engages in the holding position, wherein the slot can be very short, for example corresponding to a length of only slightly more than the undercut depth of the second closure part, but is preferably long, specifically many times longer than the undercut depth. In order to establish a hold, the head of the engagement element, for example formed by a spherical head, engages behind the edge portions, such that the engagement element is shifted along the edge portions in a form-fitting manner, with respect to the closure direction, upon displacement, and is held on the first closure part in the holding position. The displacement portion is thus open towards the outside via a slot formed between the edge portions. A space located on the inside of the latching portions is widened relative to the slot, such that the head of the engagement elements can be displaced into the displacement portion and in the process rest with the shank in the region of the slot, such that the head of the engagement element engaging behind the edge portions establishes a form-fitting hold of the closure parts on one another.

The edge portions are formed rigidly on the housing of the second closure part.

During displacement and in the holding position, the shank passes through an intermediate space between the edge portions. In contrast, the head engages behind the edge portions in a form-fitting manner, and thereby establishes the hold of the closure parts on one another. The head has a larger diameter than the shank (measured along the transverse direction, along which the edge portions are spaced apart from one another). An intermediate space between the edge portions is of such a width that the shank can pass through the intermediate space but the head cannot be moved through the intermediate space (along the closure direction). The spherical head is thus held in the displacement portion in a form-fitting manner (with respect to the closure direction).

In a non-limiting embodiment, the second closure part comprises a base. The shank is arranged on the base and carries an end of the head remote from the base. The second closure part can for example be connected to an associated assembly via the base.

In a non-limiting embodiment, the engagement element is arranged adjustably on the base. For example, in a retracted position the engagement element can be received at least in part in a receiving opening of the base, and in an operating position can be moved out of the receiving opening by the head, wherein in the operating position the engagement element can be inserted into the insertion opening and pushed into the displacement portion. This makes it possible to configure the second closure part in such a way that, in a non-use position, the engagement element is hidden and does not protrude or protrudes only insignificantly from the base. If the second closure part is not connected to the first closure part, then the engagement element is retracted into the base, for example by a magnetic effect between magnet elements arranged on the base and on the engagement element, or by the preload of a mechanical spring. When it approaches the first closure part, the engagement element is extended and thus projects out of the receiving opening, such that the engagement element can be inserted by the head into the insertion opening and can be displaced into the displacement portion

The extension of the engagement element out of the retracted position into the operating position can for example take place automatically by magnetic effect between the first magnet element on the first closure part and the second magnet element on the engagement element of the second closure part, when the closure parts are moved towards one another.

In a non-limiting embodiment, the blocking element is preloaded in the direction of the blocking position relative to the housing. Thus, owing to the preload, the blocking element assumes the blocking position on the housing when the blocking element is not actuated to move out of the blocking position. If the engagement element is in the holding position, the blocking element thus automatically assumes the blocking position and blocks the engagement element in the displacement portion.

The preload can be brought about for example by a spring mechanism, for example via a spring element, by means of which the blocking element is preloaded relative to the housing.

In a non-limiting embodiment, the preload is brought about for example magnetically. For this purpose, the blocking element can for example comprise a third magnet element which interacts in a magnetically attracting manner with the first magnet element, such that the blocking element is preloaded in the direction of the blocking position. The third magnet element can for example be configured by a permanent magnet which faces with an opposite pole towards the first magnet element. Alternatively, the third magnet element can be formed by a magnetic armature, configured from a ferromagnetic material, which interacts in a magnetically attracting manner with the first magnet element. Owing to the magnetic interaction of the first magnet element and the third magnet element, if the blocking element is not actuated the blocking element is loaded magnetically in the direction of the blocking position and thus held in the blocking position, such that the blocking element assumes the blocking position when the engagement element is in the holding position.

In a non-limiting embodiment, the blocking element is configured such that in the event of a displacement of the engagement element, in the displacement portion, in the displacement direction for moving the engagement element into the holding position, the blocking element is moved out of the blocking position. In the case of a displacement of the engagement element in the displacement portion, the engagement element thus interacts, by its head or another portion of the second closure part, with the blocking element, in order to deflect the blocking element out of the blocking position. The blocking element or the other portion of the second closure part can thus be moved beyond the engagement element, such that the engagement element can be displaced, in the displacement portion, in the direction of the holding position.

In a non-limiting embodiment, the blocking element comprises a blocking portion which, for blocking the engagement element in the blocking position, projects into the region of the displacement portion, in particular into such a region of the displacement portion within which the engagement element moves upon displacement. If the engagement element is in the holding position and the blocking element assumes the blocking position, then the engagement element is thus blocked in the displacement portion and cannot be moved out of the displacement portion.

In this embodiment, the blocking portion can for example comprise a ramp portion which is oriented obliquely to the displacement direction and onto which the head of the engagement element runs in the case of displacement in the displacement direction for transferring the engagement element into the holding position, such that as a result the blocking portion can be displaced out of the blocking position and thus the engagement element can be moved past the blocking portion. Counter to the displacement direction, the blocking portion for example forms a blocking surface, which is preferably directed at least approximately perpendicularly to the displacement direction, such that the engagement element strikes the blocking surface with its head and is thereby blocked in the displacement portion when the blocking portion is in the blocking position and the engagement element is in the holding position.

In a non-limiting embodiment, the blocking portion can also form a ramp portion counter to the displacement direction, onto which the head of the engagement element runs in the event of displacement counter to the displacement direction. This makes it possible for a user to be able to open the holding apparatus without specific actuation of the blocking element, in that the engagement element is moved counter to the displacement direction by a force that exceeds a threshold force and thereby pushes the blocking element aside, such that the blocking is overcome.

In a non-limiting embodiment, the blocking element is pivotably mounted on the housing of the first closure part. For this purpose, the blocking element can for example comprise a bearing element, for example in the form of an axle element, via which the blocking element is pivotably supported on the housing. The blocking element can thus be pivoted out of the blocking position, relative to the housing.

In particular, the blocking element can be configured in the manner of a rocker, in the case of which the blocking element is located in the blocking position in an initial position and can be tilted out of the blocking position for closing the holding apparatus and also for opening the holding apparatus, in order to automatically return to the initial position corresponding to the blocking position after actuation, on account of a preload relative to the housing of the first closure part.

In a non-limiting embodiment, the blocking element can for example be arranged in a linearly displaceable manner on the housing and be configured for example in the manner of a pin.

In a non-limiting embodiment, the blocking element comprises a handle for actuation by a user for unblocking the engagement element. While in the case of closing of the holding apparatus the blocking element can be deflected preferably automatically out of the blocking position and the closure parts can thus be moved towards one another for closing the holding apparatus, for opening the holding apparatus the blocking element can be actuated by a user in that the user acts on the handle and thereby moves the blocking element manually relative to the housing of the first closure part. The blocking element can thus be brought out of a blocking position, for example in that a blocking portion of the blocking element is displaced out of the region of the displacement portion, such that a blocking of the engagement element in the displacement portion is overcome and the closure parts can be removed from one another.

In a non-limiting embodiment, the handle is arranged on a first side of the insertion opening with respect to the displacement direction, while the displacement portion extends on a second side of the insertion opening remote from the first side. The handle on the one hand and the displacement portion on the other hand are thus located on different sides of the insertion opening. In this case, it can be provided that the handle is to be actuated with an opening movement directed in the displacement direction, for unblocking the engagement element, while the engagement element is to be displaced counter to the displacement direction along the displacement portion for separating the first closure part and the second closure part from one another. The handle and the engagement element are thus to be moved in different directions, specifically towards one another, for opening the holding apparatus. This makes opening of the holding apparatus particularly intuitive for a user, in that the user can for example act with two fingers on the handle on the one hand and on the second closure part on the other hand, in order to press these towards one another and thereby to open the holding apparatus.

In a non-limiting embodiment, a carrying apparatus comprises a holding apparatus of the type described above for carrying a tool.

In a non-limiting embodiment, a carrying apparatus comprises a holding apparatus of the type described above for carrying an electrical or electronic appliance, in particular an electrical tool, for example a cordless screwdriver or cordless drill.

### BRIEF DESCRIPTION OF THE DRAWINGS

The concept on which the present disclosure is based will be explained in greater detail in the following with reference to the embodiment shown in the figures.

FIG. 1 is an exploded view of a non-limiting embodiment of a holding apparatus for holding an object on an assembly according to the principles of the present disclosure;

FIG. 2 is another exploded view of the holding apparatus;

FIG. 3 is an exploded view, in a side view;

FIG. 4 is an exploded view, in a front-end view;

FIG. 5 is a view of the holding apparatus in an open position;

FIG. 6 is another view of the holding apparatus;

FIG. 7 is a side view of the holding apparatus;

FIG. 8 is a front-end view of the holding apparatus;

FIG. 9 is a view of the holding apparatus from below;

FIG. 10A is a front-end view of the holding apparatus;

FIG. 10B is a sectional view along the line A-A according to FIG. 10A;

FIG. 11A is a plan view of the holding apparatus in an open position;

FIG. 11B is a sectional view along the line A-A according to FIG. 11A;

FIG. 11C is a side view of the holding apparatus;

FIG. 11D is a front-end view of the holding apparatus;

FIG. 11E is a sectional view along the line B-B according to FIG. 11D;

FIG. 12A is a plan view of the holding apparatus during insertion of an engagement element of a second closure part into an insertion opening of a first closure part;

FIG. 12B is a sectional view along the line A-A according to FIG. 12A;

FIG. 12C is a side view of the holding apparatus;

FIG. 12D is a front-end view of the holding apparatus;

FIG. 12E is a sectional view along the line B-B according to FIG. 12D;

FIG. 13A is a plan view of the holding apparatus during insertion of an engagement element of the second closure part into a displacement portion of the first closure part;

FIG. 13B is a sectional view along the line A-A according to FIG. 13A;

FIG. 13C is a side view of the holding apparatus;

FIG. 13D is a front-end view of the holding apparatus;

FIG. 13E is a sectional view along the line B-B according to FIG. 13D;

FIG. 14A is a plan view of the holding apparatus during displacement of the engagement element of the second closure part over a blocking element of the first closure part;

FIG. 14B is a sectional view along the line A-A according to FIG. 14A;

FIG. 14C is a side view of the holding apparatus;

FIG. 14D is a front-end view of the holding apparatus;

FIG. 14E is a sectional view along the line B-B according to FIG. 14D;

FIG. 15A is a plan view of the holding apparatus during further displacement of the engagement element;

FIG. 15B is a sectional view along the line A-A according to FIG. 15A;

FIG. 15C is a side view of the holding apparatus;

FIG. 15D is a front-end view of the holding apparatus;

FIG. 15E is a sectional view along the line B-B according to FIG. 15D;

FIG. 16A is a plan view of the holding apparatus in a holding position of the engagement element;

FIG. 16B is a sectional view along the line A-A according to FIG. 16A;

FIG. 16C is a side view of the holding apparatus;

FIG. 16D is a front-end view of the holding apparatus;

FIG. 16E is a sectional view along the line B-B according to FIG. 16D;

FIG. 17 is a view of the holding apparatus comprising an object, in the form of a tool, arranged on the second closure part, for connection to an assembly in the form of a belt;

FIG. 18A is a schematic view of the engagement element prior to insertion into a displacement portion;

FIG. 18B is a schematic view of the engagement element during insertion into the displacement portion;

FIG. 18C is a view of the engagement element in the holding position, corresponding to an end position when fully inserted into the displacement portion;

FIG. 19A is a perspective exploded view of a further embodiment of a holding apparatus;

FIG. 19B is another exploded view of the holding apparatus;

FIG. 20A is a perspective view of the holding apparatus in a non-connected position of two closure parts;

FIG. 20B is another view of the arrangement according to FIG. 20A;

FIG. 20C is yet another view of the arrangement according to FIG. 20A;

FIG. 20D is a side view of the arrangement according to FIG. 20A;

FIG. 20E is a plan view of the arrangement according to FIG. 20A;

FIG. 20F is a sectional view along the line A-A according to FIG. 20E;

FIG. 20G is a sectional view along the line B-B according to FIG. 20E;

FIG. 21A is a perspective view of the holding apparatus during attachment of the closure parts to one another;

FIG. 21B is another view of the arrangement according to FIG. 21A;

FIG. 21C is yet another view of the arrangement according to FIG. 21A;

FIG. 21D is a side view of the arrangement according to FIG. 21A;

FIG. 21E is a plan view of the arrangement according to FIG. 21A;

FIG. 21F is a sectional view along the line A-A according to FIG. 21E;

FIG. 21G is a sectional view along the line C-C according to FIG. 21E;

FIG. 21H is a sectional view along the line F-F according to FIG. 21G;

FIG. 22A is a perspective view of the holding apparatus during insertion of an engagement element of one closure part into a displacement portion of the other closure part;

FIG. 22B is another view of the arrangement according to FIG. 22A;

FIG. 22C is yet another view of the arrangement according to FIG. 22A;

FIG. 22D is a side view of the arrangement according to FIG. 22A;

FIG. 22E is a plan view of the arrangement according to FIG. 22A;

FIG. 22F is a sectional view along the line A-A according to FIG. 22E;

FIG. 22G is a sectional view along the line D-D according to FIG. 22E;

FIG. 22H is a sectional view along the line G-G according to FIG. 22G;

FIG. 23A is a perspective view of the holding apparatus during attachment of the closure parts to one another;

FIG. 23B is another view of the arrangement according to FIG. 23A;

FIG. 23C is yet another view of the arrangement according to FIG. 23A;

FIG. 23D is a side view of the arrangement according to FIG. 23A;

FIG. 23E is a plan view of the arrangement according to FIG. 23A;

FIG. 23F is a sectional view along the line A-A according to FIG. 23E;

FIG. 23G is a sectional view along the line E-E according to FIG. 23E; and

FIG. 23H is a sectional view along the line H-H according to FIG. 23G.

### DETAILED DESCRIPTION

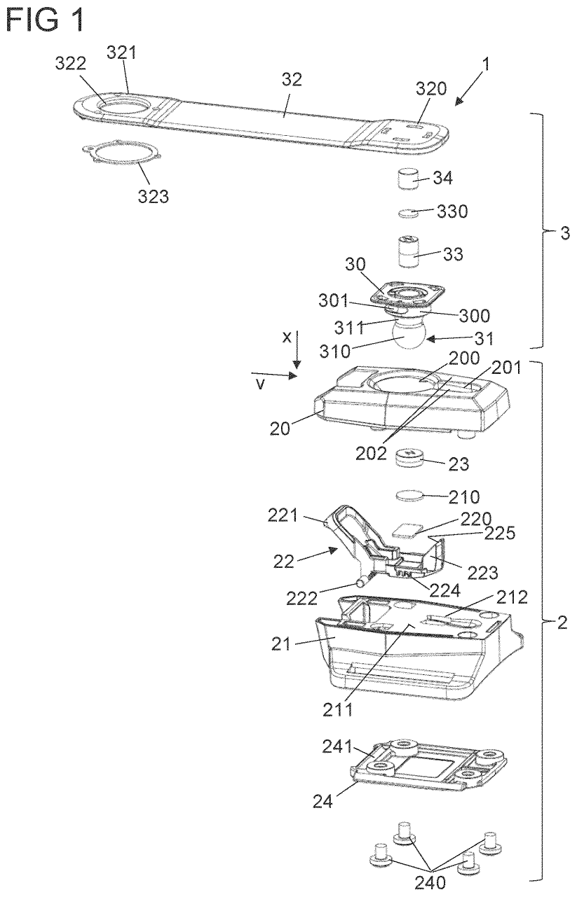

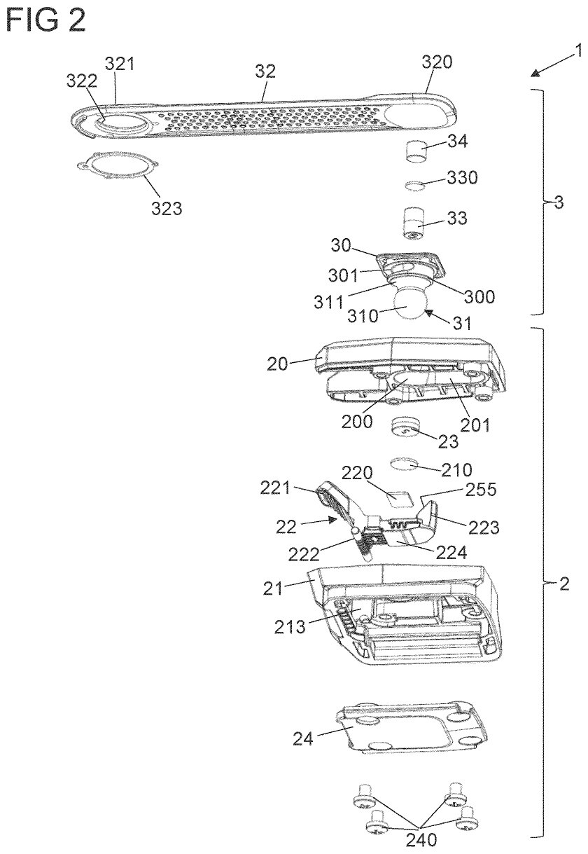

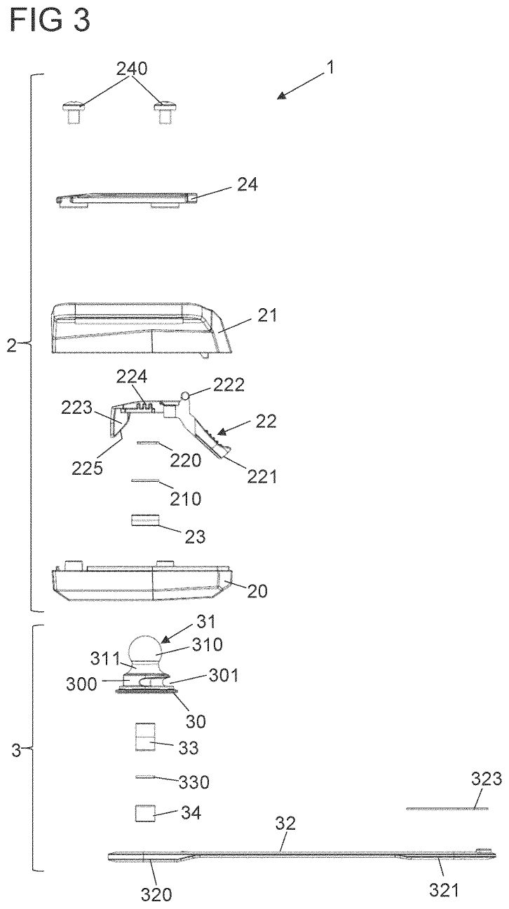

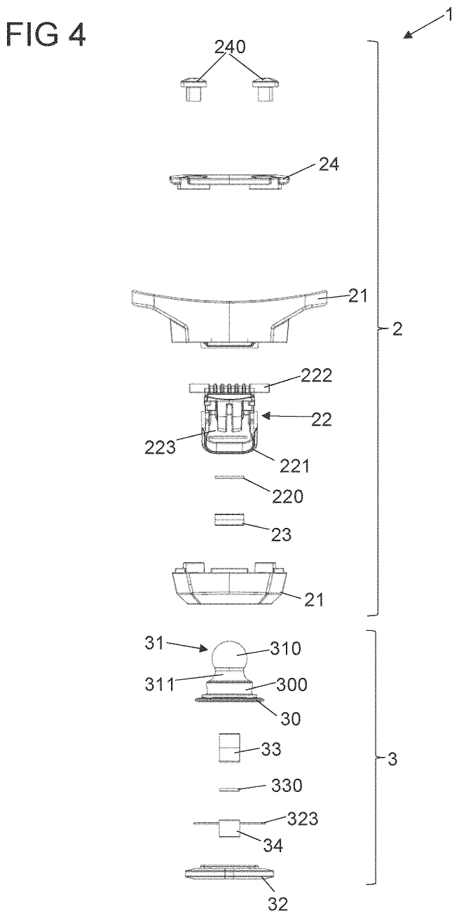

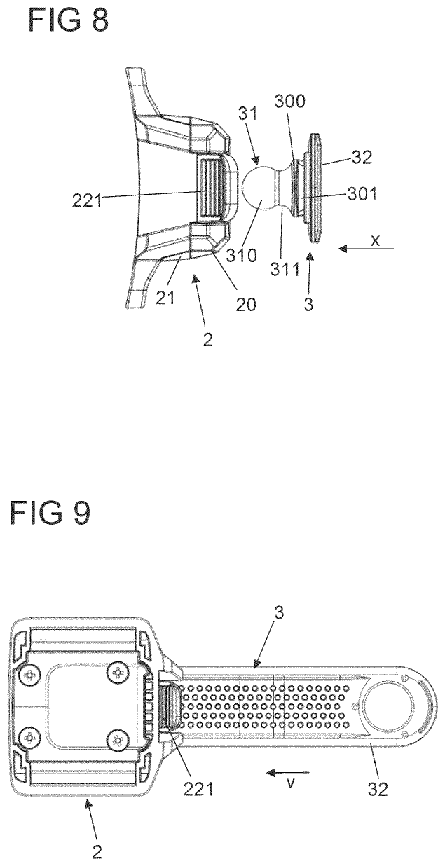

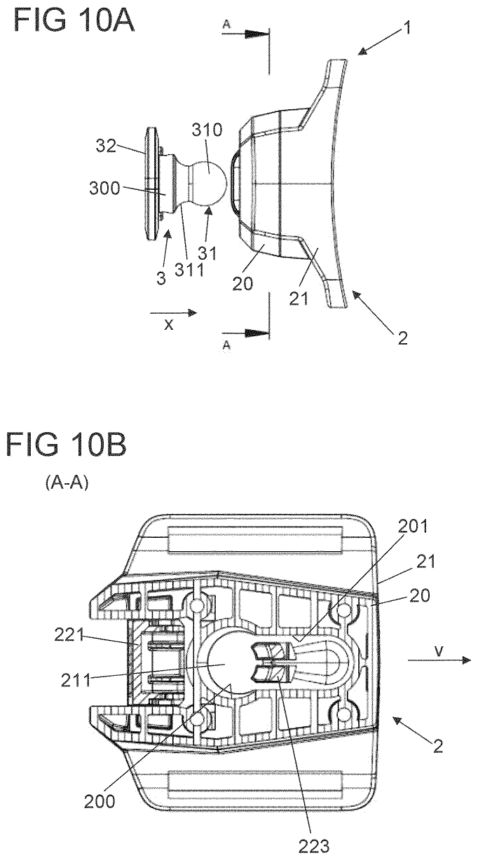

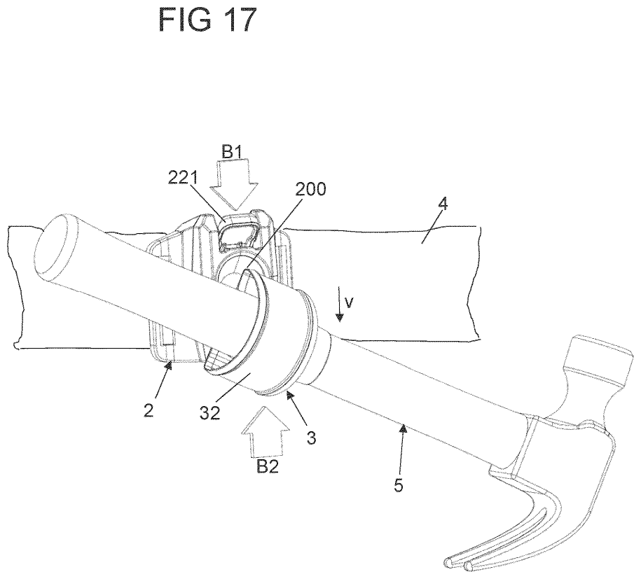

FIGS. 1 to 17 are views of a non-limiting embodiment of a holding apparatus 1 which serves for holding an object 5 shown in FIG. 17, for example a tool, on an associated assembly 4, for example a belt.

The holding apparatus 1 comprises a first closure part 2 and a second closure part 3 which can be attached to one another along a closure direction X and provide a secure hold on one another in a holding position. In this case, the first closure part 2 can for example be connected to the assembly 4, for example the belt. The second closure part 3 can for example be associated with the object 5, for example the tool, and thus carry the object.

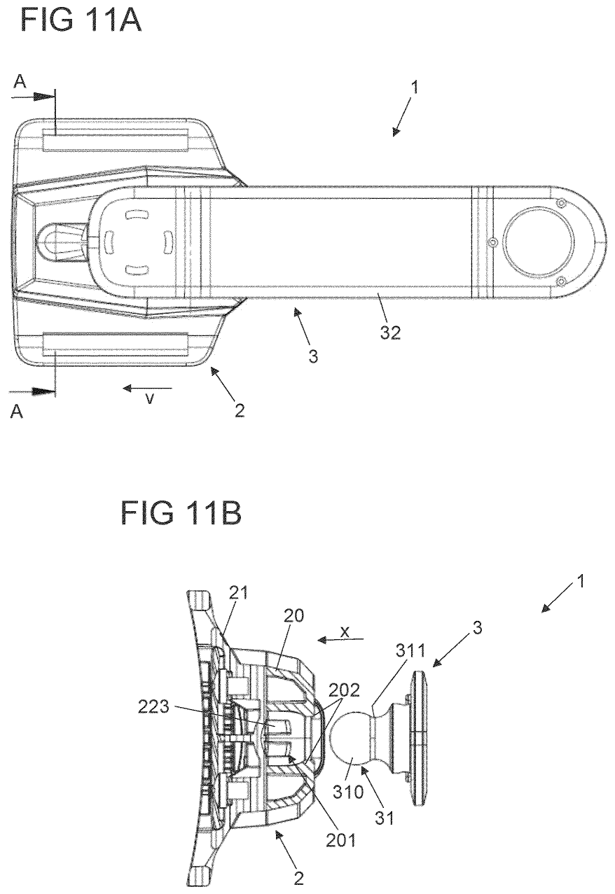

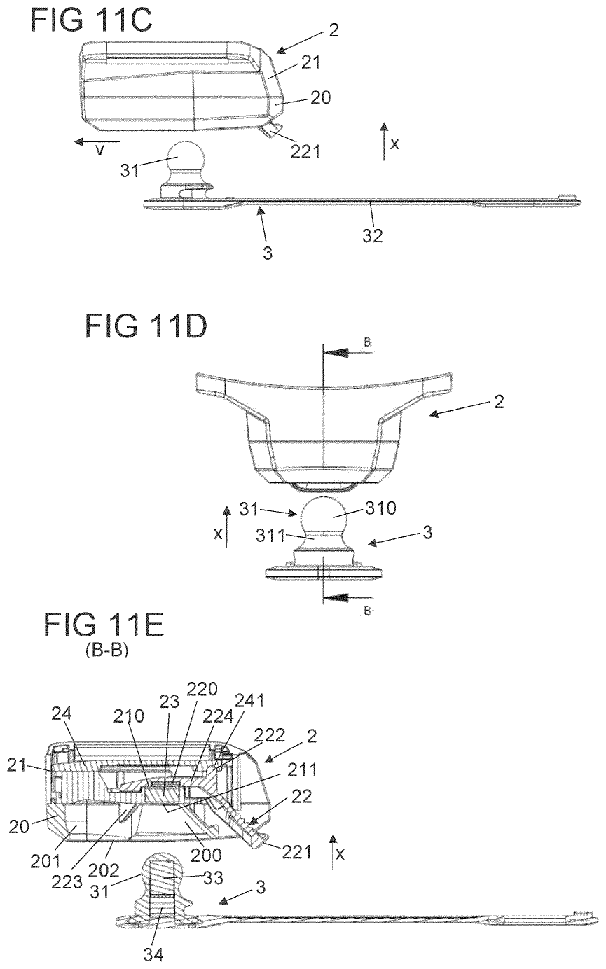

The first closure part 2 comprises a housing which is formed by housing parts 20, 21, 24. An insertion opening 200 is formed in the housing part 20, which is adjoined by a displacement portion 201 extending along a displacement direction V. The displacement portion 201 is delimited by edge portions 202 which extend along the displacement direction V and are oriented in parallel with one another, which protrude inwards (towards one another) with respect to an interior of the displacement portion 201 (see for example the sectional view according to FIG. 11B) and thus define a slot which has a reduced width compared with an interior space of the displacement portion 201, as can be seen in the sectional view according to FIG. 11B.

The second closure part 3 comprises a base 30 and an engagement element 31 arranged on the base 30. The engagement element 31 comprises a head 310 in the form of a spherical head, which is connected to the base 30 via a shank 311.

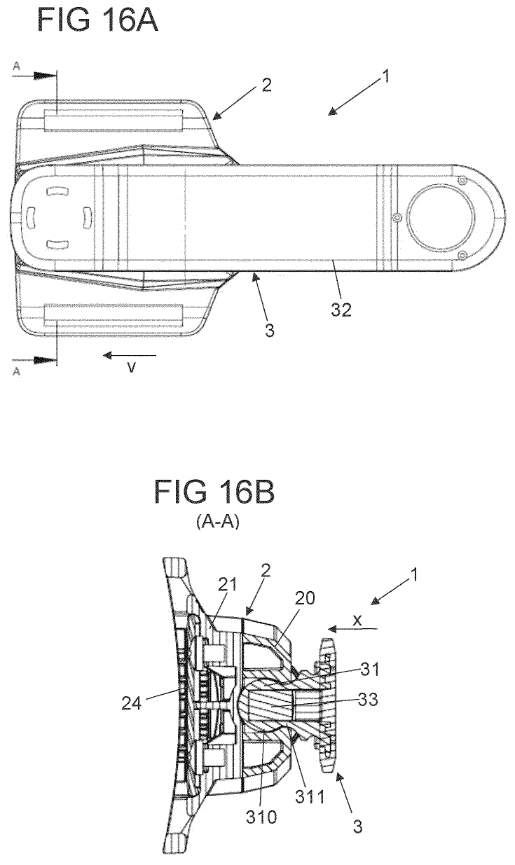

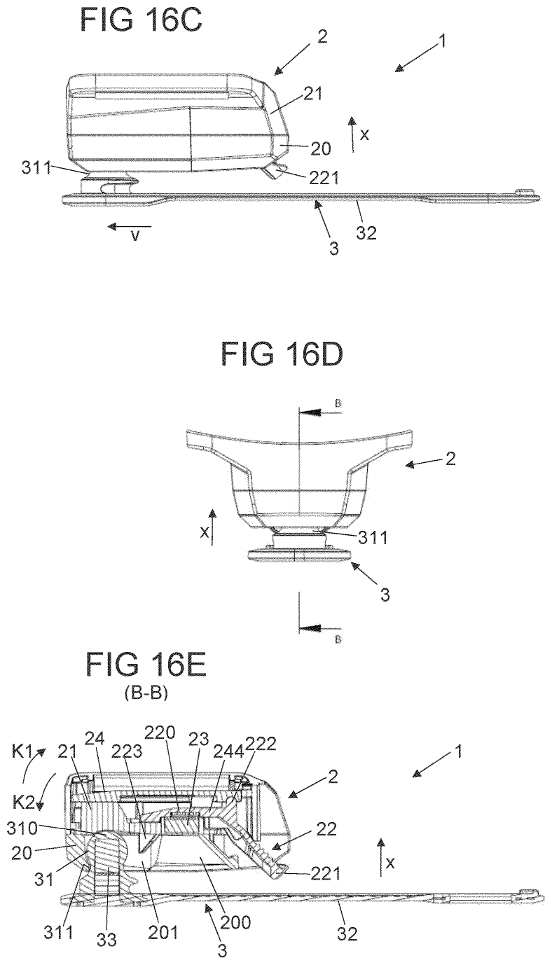

In order to interconnect the closure parts 2, 3, the second closure part 3 can be inserted by the engagement element 31 into the insertion opening 200. In this case, the insertion opening 200 has a substantially circular opening shape and tapers conically inwards, such that when the engagement element 31 is inserted into the insertion opening 200, in the closure direction X, the engagement element 31 is conducted by the head 310 into the region of the inlet of the displacement portion 201. For further connection of the closure parts 2, 3, the engagement element 31 can then be pushed by the head 310 into the displacement portion 201, such that the shank 311 penetrates through the slot formed between the edge portions 202 and the head 310 lies in the interior of the displacement portion 21 and thereby establishes a form-fitting connection between the closure parts 2, 3, as can be seen for example from the sectional view according to FIG. 16B.

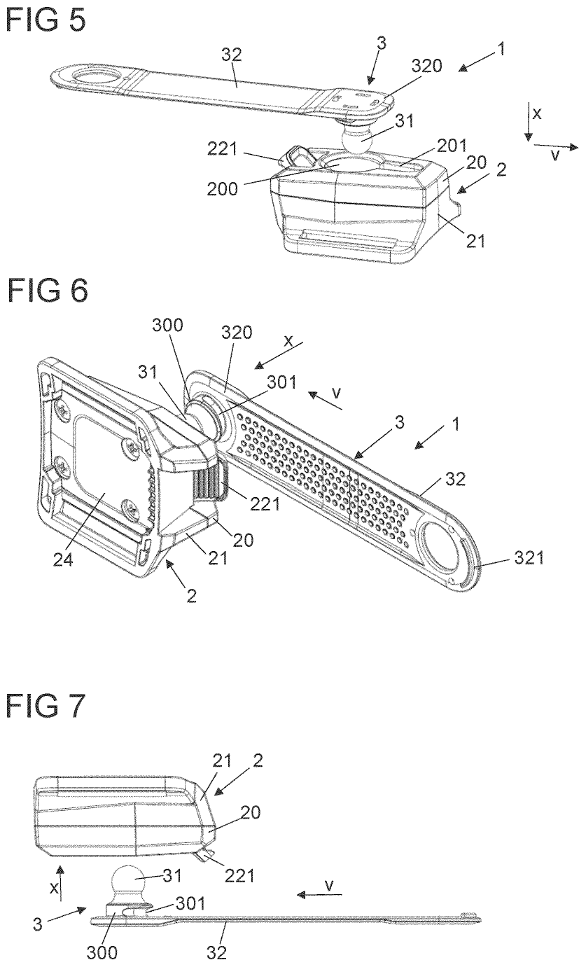

In the mounted position, the housing parts 20, 21, 24 of the housing of the first closure part 2 are rigidly interconnected. The housing part 21 forms a receiving space 213 in its interior, in which a blocking element 22 is received which is pivotably mounted on a bearing surface 241 of the housing part 24 via a bearing element 222 in the form of an axle element. The blocking element 22 is thus pivotable on the housing, wherein a handle 221 protrudes towards the outside from the housing and can be actuated by a user for unblocking the holding apparatus 1, as can be seen for example from FIGS. 5 and 6.

The blocking element 22 projects into the region of the displacement portion 201 by a blocking portion 223 arranged on a base portion 224, when the blocking element 22 is in a blocking position, such that the engagement element 31 is thereby blocked in its holding position in the displacement portion 201, as can be seen from the sectional view according to FIG. 16E.

The housing part 21 forms a bottom 211 which forms the bottom of the insertion opening 200 and of the displacement portion 201. An opening 212 is formed in the bottom 211, through which opening the blocking portion 225 passes when the blocking element 22 is in the blocking position.

The housing part 24 is fixed on the housing part 21 via fastening elements 240 in the form of screws. The housing parts 20, 21 are also fixed to one another, for example via screws or via an adhesive connection.

The first closure part 2 comprises a first magnet element 23, for example in the form of a permanent magnet, which is arranged on the housing part 21, as can be seen for example from the sectional view according to FIG. 11E. The second closure part 3 comprises a second magnet element 33 which is received inside the engagement element 31 and in this case is arranged concentrically to the rotationally symmetrical engagement element 33, as can be seen for example from FIG. 11E.

The magnet element 23 is received on the housing part 21 and covered by a (non-magnetic) plate element 210 with respect to a side facing inwards, away from the bottom 211.

Furthermore a third magnet element 220 is arranged on the blocking element 22, which third magnet element is received on the base portion 224 and interacts magnetically with the magnet element 23 on the housing part 21, in order to preload the blocking element 22 in the direction of the blocking position. Thus the magnet element 220, for example in the form of a magnetic armature, interacts in a magnetically attracting manner with the magnet element 23 on the housing part 21, such that the base portion 224 is drawn in the direction of the magnet element 23, as can be seen for example from FIG. 11E, and as a result the blocking element 22 is held magnetically in the blocking position shown in FIG. 11E, when the blocking element 22 is not deflected out of the blocking position by actuation for opening or by interaction with the engagement element 31 during closing.

The magnet element 33 is received inside the engagement element 31. Furthermore, a further magnet element 34 is arranged in a receiving opening inside the engagement element 31 and separated from the magnet element 33 by a plate element 330, as can be seen from FIG. 11E. The magnet element 34, for example in the form of a permanent magnet, serves for interaction with a magnetic, for example ferromagnetic, annular element 323 of a holding element 32 connected to the base 30, for example in the form of a band, in order to thereby interconnect ends 320, 321 of the holding element 32, as can be seen from FIG. 17.

Thus, in order to form a loop, the end 321 having the opening 322 formed therein can be attached to the engagement element 31 and a holding portion 300 adjoining the shank 311, wherein an undercut portion 301 in the form of a notch is formed on the holding portion 300, into which notch the end 321 having the annular element 323 arranged thereon can be hooked. In this case, the connection by engagement in the undercut portion 301 is established automatically in a magnetically assisted manner by magnetic interaction between the magnet element 34 and the annular element 323, such that after the loop is formed the end 321 of the holding element 32 is held firmly and reliably on the holding portion 300 of the base 30.

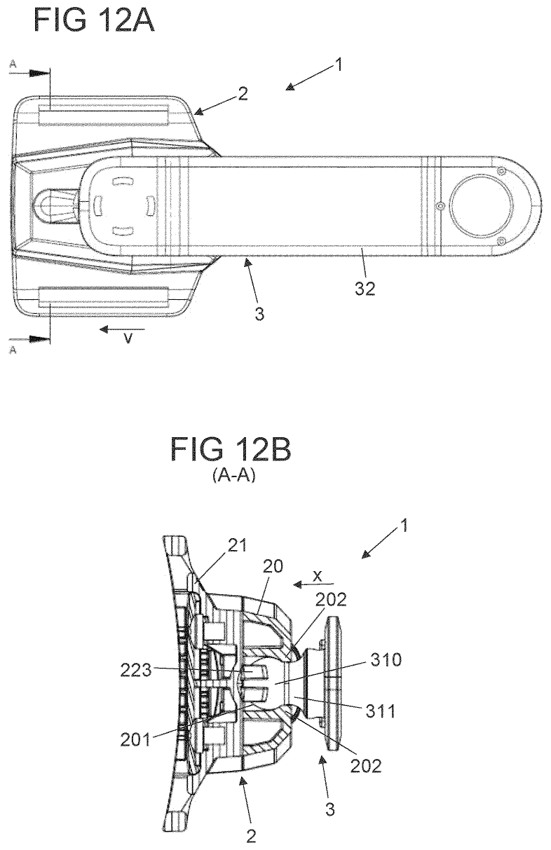

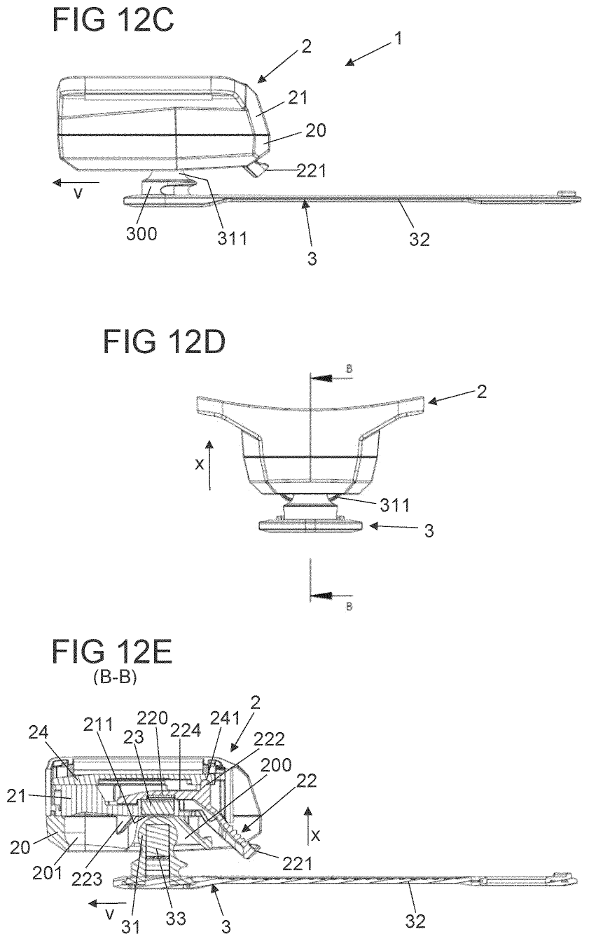

In order to establish the connection between the closure parts 2, 3 of the holding apparatus 1, the engagement element 31 is inserted into the insertion opening 200 on the closure part 2 in the closure direction X, as can be seen from FIGS. 11A to 11E and FIGS. 12A to 12E. In this case, the magnet element 23 of the closure part 2 is arranged on the bottom 211 of the housing part 21, in the region of the insertion opening 200, as can be seen from FIG. 11E, such that the head 310 of the engagement element 31 is drawn magnetically ingo engagement with the insertion opening 200 by magnetic interaction between the magnet elements 23, 33. The closure parts 2, 3 are thus automatically, in a magnetically assisted manner, when they approach one another, such that the closing process is magnetically assisted.

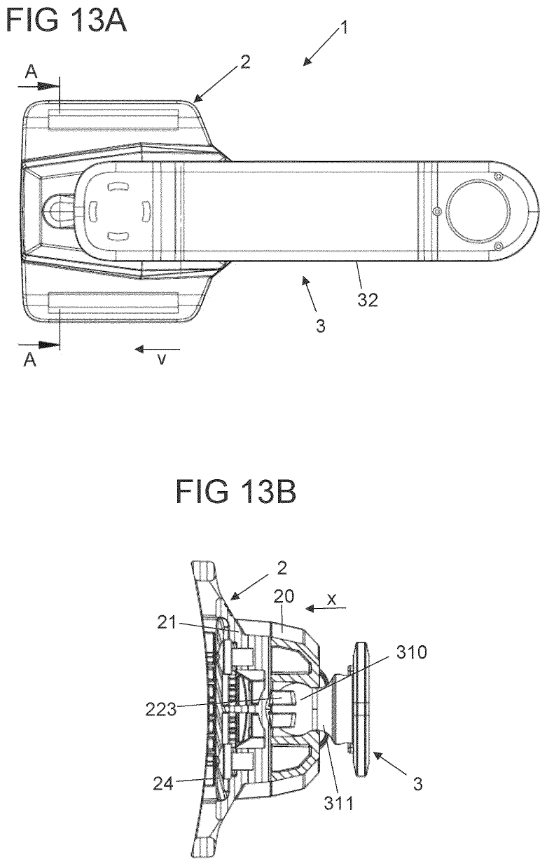

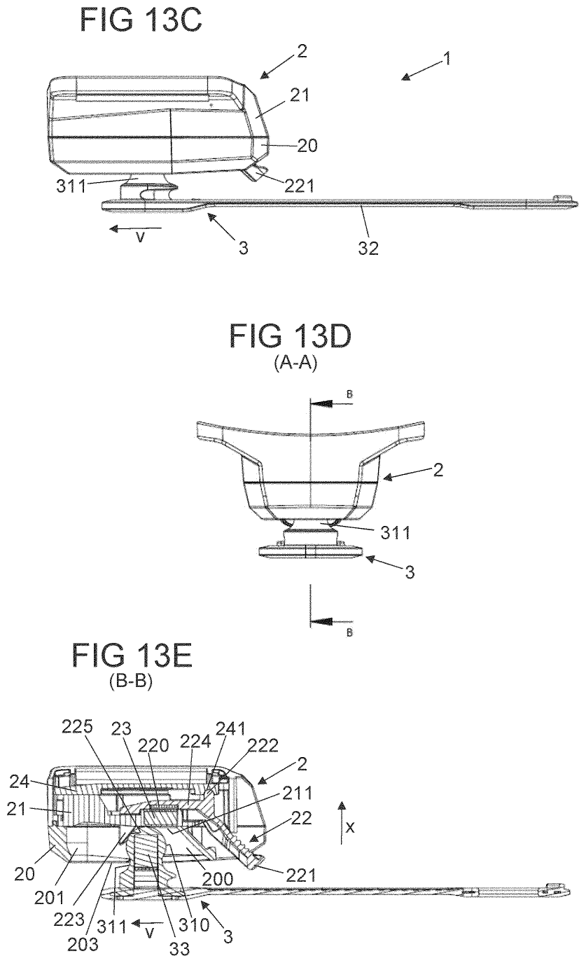

The conical shape of the insertion opening 200 means that the head 310 of the engagement element 31 is guided, after insertion into the insertion opening 200, into the region of the inlet of the displacement portion 201, as can be seen from FIG. 12A to 12E. As shown in FIGS. 13A to 13E, the head 310 of the engagement element 31 can thus be pushed into the displacement portion 201 in such a way that the head 310 engages behind the edge portions 202 and the shank 311 passes through the slot formed between the edge portions 202, as can be seen from FIGS. 13B and 13E.

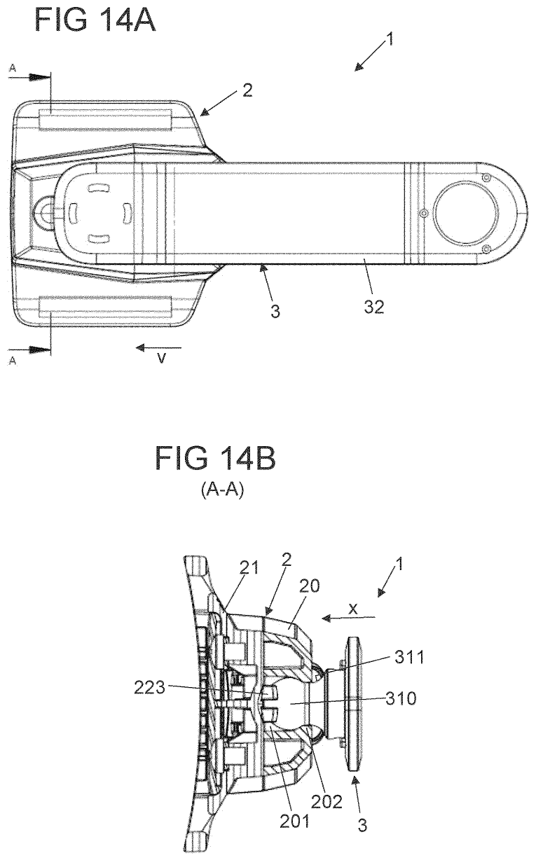

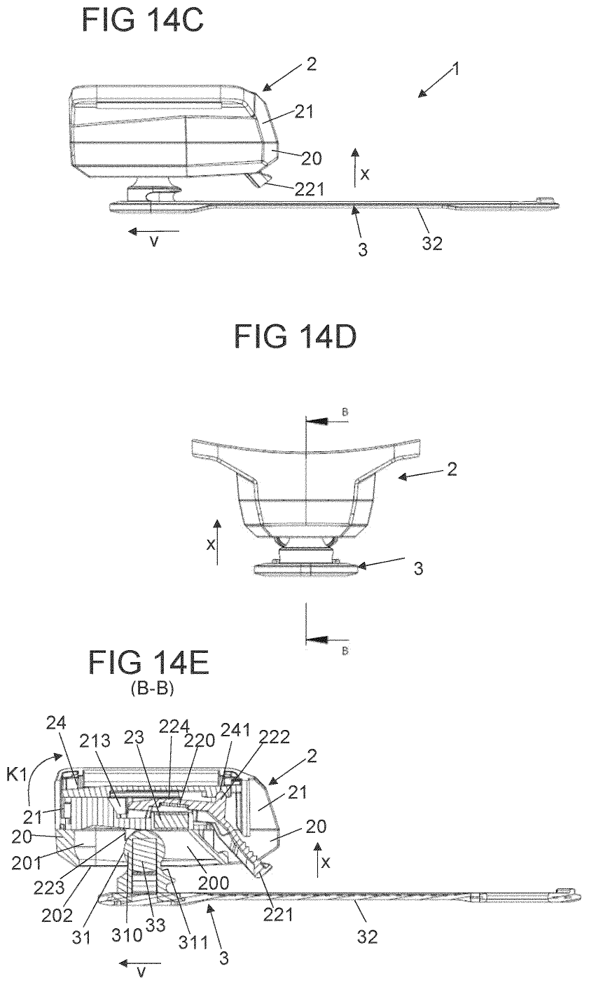

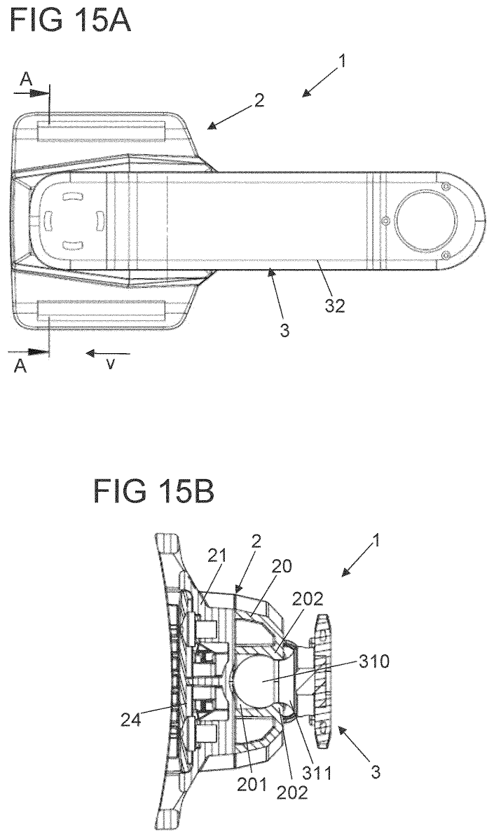

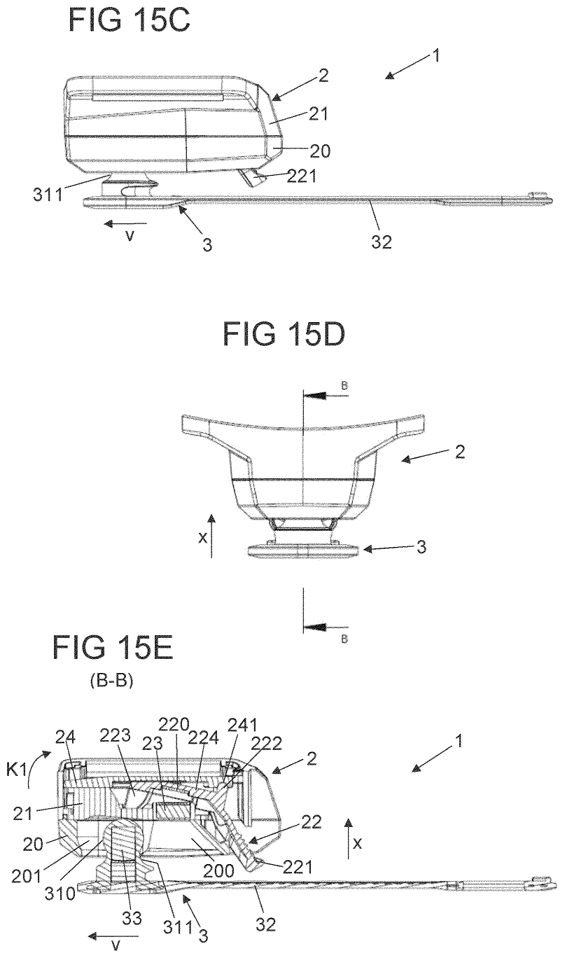

In order to establish the connection, the engagement element 31 is pushed into the displacement portion 201 in the displacement direction V. In this case, the head 310 of the engagement element 31 comes into interaction with the blocking portion 223 of the blocking element 22 projecting into the displacement portion 201, wherein the spherical head 310 runs onto a ramp portion 225 oriented obliquely to the displacement direction V and thus pushes the blocking portion 223 aside, as can be seen from FIGS. 14A to 14E and 15A to 15E. The engagement element 31 is thus moved past the blocking portion 223 with deflection of the blocking element 22 into a tilting direction K1, until the head 310 of the engagement element 31 has passed the blocking portion 223 and the blocking element 22 returns to its blocking position in a tilting direction K2 opposite the tilting direction K1, as can be seen from FIGS. 16A to 16E.

The return of the blocking element 22 takes place on account of the magnetic preload of the blocking element 22 into the blocking position, brought about by the magnet elements 23, 220. Thus, the magnet elements 23, 220 attract one another magnetically and return the blocking element 22, following deflection, back into the blocking position according to FIG. 16E.

In the blocking position, the blocking portion 223 projects into the displacement portion 201 and thus blocks the engagement element 31 in the displacement portion 201. In this case, the engagement element 31 is located in an end of the displacement portion 201 and is held there for example by the action of gravity. In this case, the engagement element 31 cannot be moved out of the displacement portion 201 counter to the displacement direction V, because this is prevented by the blocking portion 223 of the blocking element 22.

For this purpose, the blocking portion 223 comprises a surface portion that is perpendicular to the displacement direction V, on a side facing towards the engagement element 31 in the holding position according to FIG. 16E, such that the engagement element 31, when it is displaced, in the blocking position of the blocking element 22, counter to the displacement direction V in the displacement portion 201, strikes the blocking portion 223 and thus cannot be moved out of the displacement portion 201.

If a user wishes to open the holding apparatus 1, then the user can actuate the blocking element 22 via the handle 221 in that the user pushes or pulls on the handle 221 and thereby deflects the blocking element 22 in the tilting direction K1. The engagement element 31 is thus unblocked, such that the engagement element 31 can be moved out of the displacement portion 201 and the holding apparatus 1 can thus be opened in order to separate the object 5 from the assembly 4.

As is shown in FIG. 17, the opening can also be performed intuitively by a user, in that the user for example acts on the handle 221 of the blocking element 22 with two fingers, in a movement direction B1, and at the same time displaces the engagement element 31 in an opposite movement direction B2 in the displacement portion 201 in the direction of the insertion opening 200, such that the engagement element 31 is moved out of the displacement portion 201 and the closure parts 2, 3 can thus be separated from one another. Since the opening can thus take place using two fingers, the opening movement is easy and comfortable for a user.

As can be seen from FIGS. 11A to 11E in overview with FIGS. 16A to 16E, the insertion of the engagement element 31 into the insertion opening 200 is magnetically assisted by the magnet elements 23, 33, such that the closure parts 2, 3 close easily. In the holding position according to FIGS. 16A to 16E, the magnet element 33 on the engagement element 31 is, in contrast, displaced transversely along the displacement direction V relative to the magnet element 23, such that the magnetic attraction between the magnet elements 23, 33 is weakened in the holding position. In the holding position, the closure parts 2, 3 are held against one another owing to the form-fitting connection established via the engagement element 31, but not magnetically.

Since the magnet elements 23, 33 are moved towards one another upon opening of the holding apparatus 1, counter to the displacement direction V, the magnet elements 23, 33 can magnetically assist the opening, in particular the displacement of the engagement element 31 counter to the displacement direction V in the displacement portion 201 in the direction of the insertion opening 200.

Since the blocking element 22 is arranged with the blocking portion 223 inside the displacement portion 201, in particular in the region of the inlet of the displacement portion 201, a reliable blocking effect between the closure parts 2, 3 results. Without actuating the blocking element 22, the holding apparatus 1 cannot be opened, such that unintentional release of the closure parts 2, 3 from one another is reliably prevented.

Since the blocking element 22 is (magnetically) preloaded in the direction of the blocking position, the blocking takes place automatically upon connection of the closure parts 2, 3, such that the holding apparatus 1 is securely and reliably blocked in the holding position, without any particular action by a user being required for this.

The fact that the engagement element 31 is spherical means that the engagement element 31 can be attached to the closure part 2 in any rotational position and can also be turned as desired, relative to the closure part 2, in the holding position.

If the shank 311 exhibits clearance within the slot formed between the edge portions 202, then furthermore pivoting of the engagement element 31 in a plane oriented perpendicularly to the displacement direction V can take place in a certain angle range.

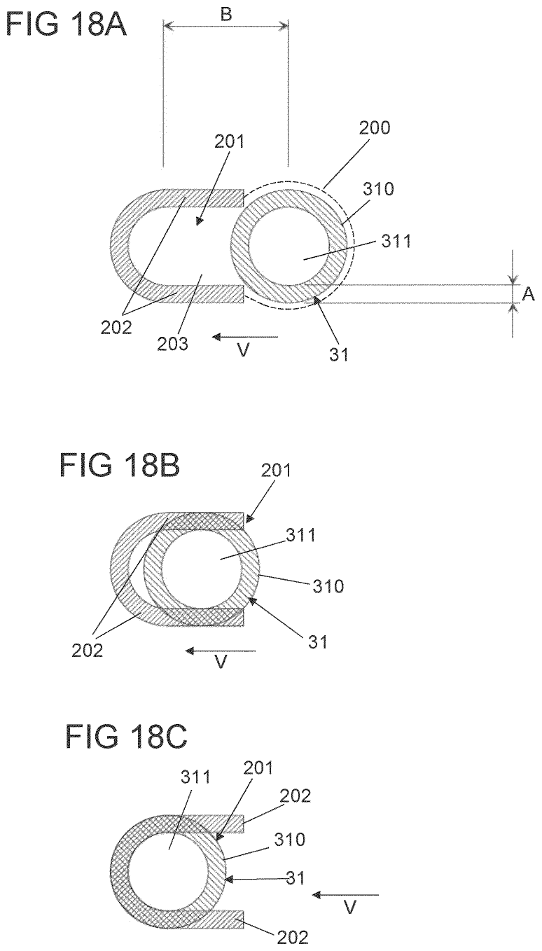

FIGS. 18A-18C are schematic views of the attachment of the engagement element 31 of the second closure part 3 to the first closure part 2 (FIG. 18A), the insertion of the head 310 of the engagement element 31 into the displacement portion 201 between the edge portions 202 (FIG. 18B), and the engagement element 31 in an end position, corresponding to the holding position, in the displacement portion 201 (FIG. 18C).

The displacement portion 201 is of a length B which corresponds to the length of the displacement path along which the engagement element 31 is to be pushed into the displacement portion 201, in the displacement direction V. The length B of the displacement portion 201 results for example from the length of the path of the engagement element 31 between the position in which the engagement element 31 is inserted into the insertion opening 200 but the head 310 is not (yet) overlapping with the edge portions 202 (corresponding to the position according to FIG. 18A), and the holding position, corresponding to the end position of the engagement element 31 on the displacement path, shown in FIG. 18C.

The engagement element 31 is inserted into the insertion opening 200 without the edge portions 202 opposing this, such that the engagement element 31, after insertion into the insertion opening 200, enters the position according to FIG. 18A, and is not yet in engagement with the edge portions 202. By displacement of the engagement element 31 in the displacement direction V into the displacement portion 201, the head 310 of the engagement element 31 comes into a position overlapping with the edge portions 202, such that the head 310 engages behind the edge portions 202 and thus slides on the edge portions 202 in a form-fitting manner. In the holding position (FIG. 18C), the engagement element 31 assumes an end position in the displacement portion 201, in which the engagement element 31 cannot be moved any further in the displacement direction V relative to the edge portions 202.

The longitudinal extension of the edge portions 202, measured along the displacement direction V, is greater than the undercut depth A of the head 310, by which the head 310 projects radially beyond the shank 311. The length of the edge portions 202 is preferably multiple times greater than the undercut depth A, wherein it is, however, also conceivable and possible for the length B to be only slightly greater than the undercut depth A, such that the displacement path is comparatively short.

It is conceivable and possible for the displacement portion 201 to for example be wider than it is long.

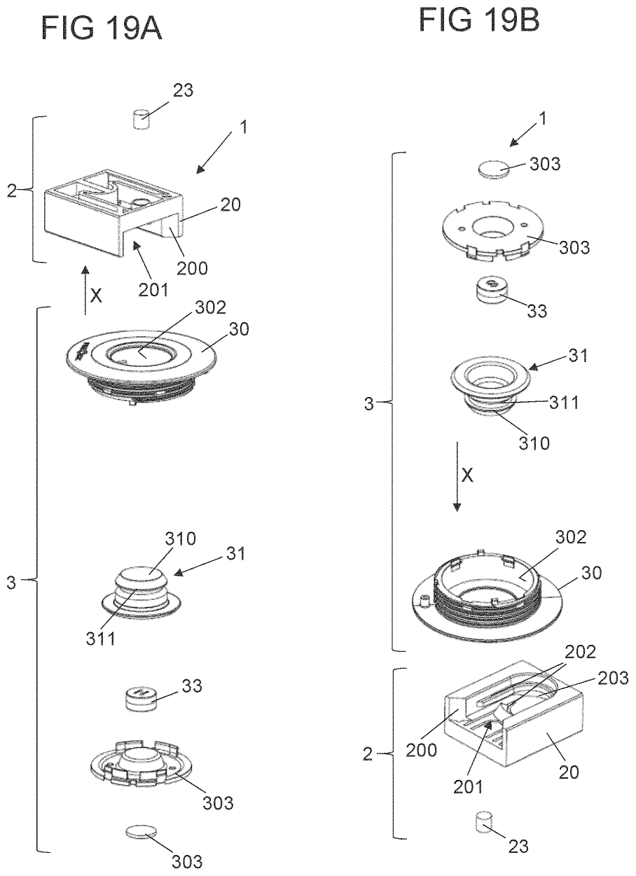

FIGS. 19A, 19B to 23A-23H show a non-limiting embodiment of a holding apparatus 1 which comprises closure parts 2, 3 that can be attached to one another for connecting the closure parts 2, 3 along a closure direction X.

In the embodiment shown, the second closure part 3 comprises a base 30 on which one engagement element 31 is arranged so as to be displaceable along the closure direction X. In a retracted position, the engagement element 31 is received in a receiving opening 302 of the base 30, and is thus enclosed in the base 30.

The engagement element 31 can be moved out of the retracted position, in the closure direction X, in order to protrude from the base 30 in an operating position, in such a way that the head 310 of the engagement element 31 can be inserted into an insertion opening 200 on a housing part 20 of the first closure part 2 and can be pushed, along a displacement direction V, into a displacement portion 201 formed on the housing part 20.

Analogously to the case in the embodiment described above, the first closure part 2 comprises a magnet element 23 which is arranged in the region of the insertion opening 200 on the housing part 20. The second closure part 3 comprises a magnet element 33 which is arranged in the head 310 of the engagement element 31.

The head 310 adjoins a shank 311 which has a reduced diameter compared with the head 310, such that the head 310 protrudes radially with respect to the shank 311 and thus forms an undercut which, when the engagement element 31 is inserted, in the displacement direction V, into a displacement portion 201 adjoining the insertion opening 200, comes into engagement with edge portions 202 on walls laterally defining the displacement portion 200, and thereby engages behind the edge portions 202.

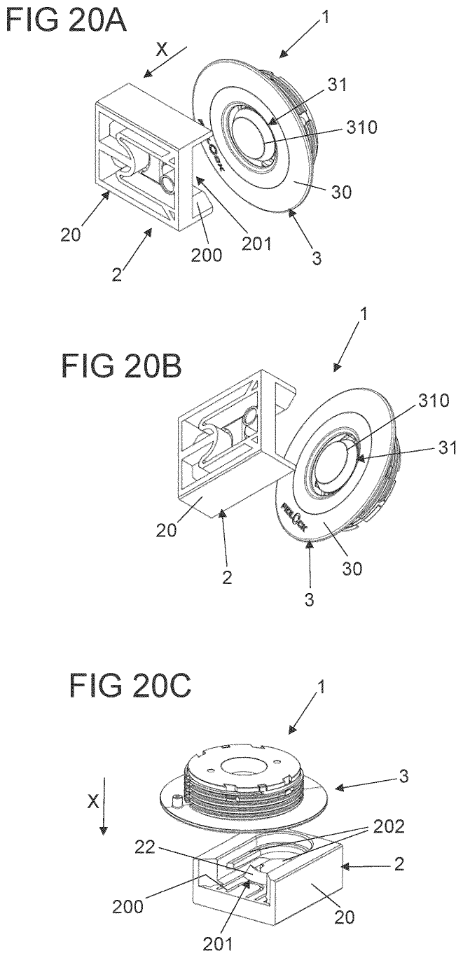

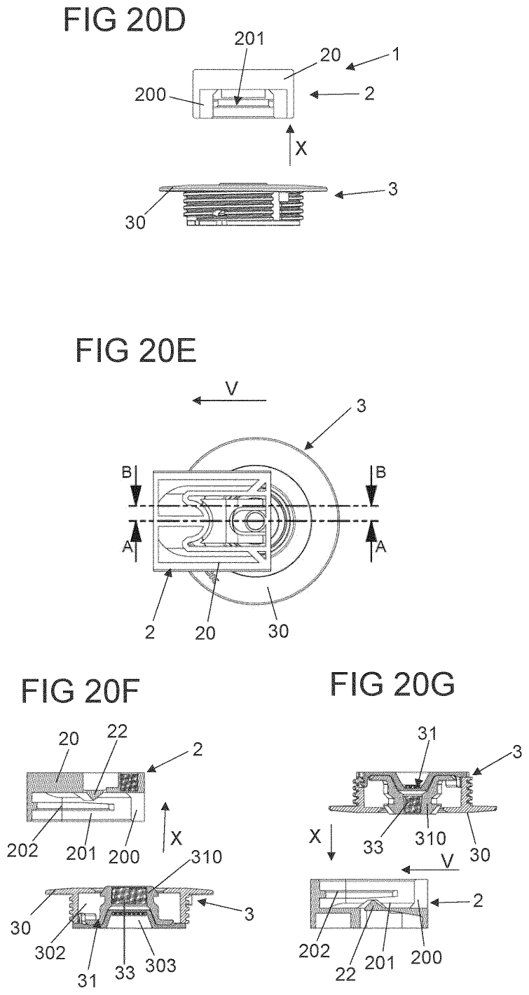

For interconnecting the closure parts 2, 3, the closure parts 2, 3 are, as shown in FIGS. 20A to 20G, attached to one another along the closure direction X. Prior to the closure parts 2, 3 being attached to one another, the engagement element 31 is in this case in the retracted position within the base 30, such that the head 310 of the engagement element 31 does not protrude or at least protrudes only slightly from the base 30 towards the outside.

As can be seen from the exploded views according to FIGS. 19A, 19B and the sectional view according to FIG. 20F, a magnet element 303 is arranged on a bottom of the receiving opening 302 of the base 30, which magnet element interacts in a magnetically attracting manner with the magnet element 33 on the engagement element 31, such that the engagement element 31 is thereby preloaded into the retracted position and, if the closure part 3 is not connected to the closure part 2, is held in the retracted position.

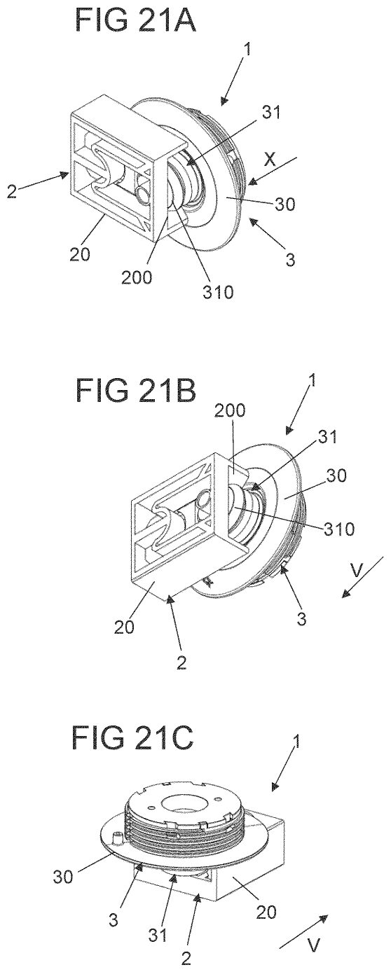

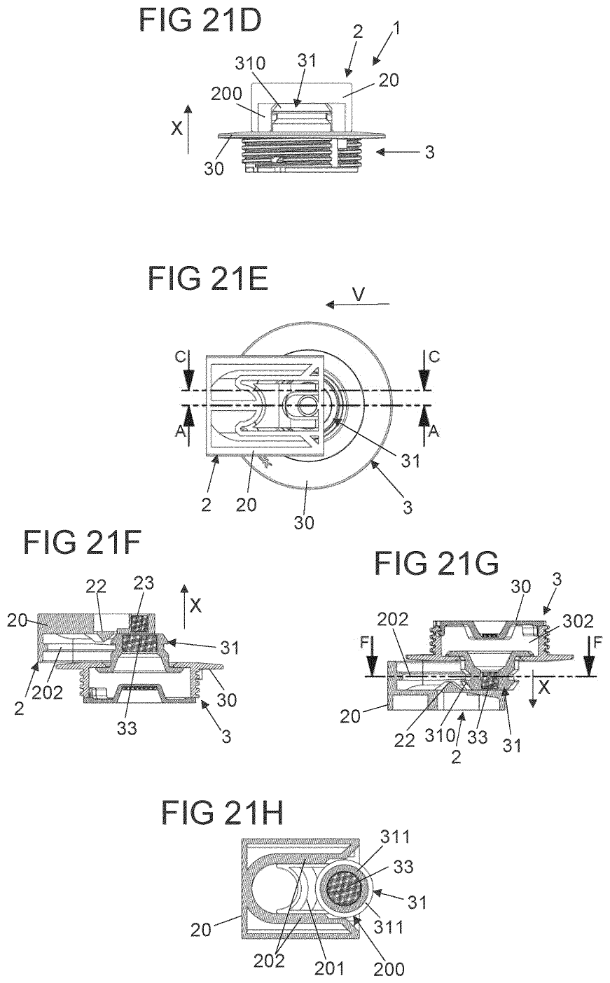

When the closure parts 2, 3 are attached to one another, the magnet elements 23, 33 of the closure parts 2, 3 are moved towards one another and interact in a magnetically attracting manner, wherein the magnetic attractive force between the magnet elements 23, 33 exceeds the attractive force between the magnet element 33 on the engagement element 31 and the magnet element 303 on the bottom of the receiving opening 302 of the base 30. As can be seen from FIGS. 21A to 21H, the engagement element 31 is thus moved out of the retracted position and enters an operating position in which the head 310 of the engagement element 31 protrudes from the base 30.

Owing to the magnetic attraction between the magnet elements 23, 33 of the closure parts 2, 3, the head 310 of the engagement element 31 is drawn into the insertion opening 200 on the housing part 20 the closure part 2 and enters the position according to FIGS. 21A to 21H. The engagement element 31 is thus automatically with the insertion opening 200.

From the position shown in FIGS. 21A to 21H, the closure part 3 can now be displaced in the displacement direction V, relative to the closure part 2, such that the head 310 of the engagement element 31 is moved into the displacement portion 201 and in the process the engages behind the edge portions 202 on the lateral walls of the displacement portion 201. In this case, the shank 311 extends through between the edge portions 202, such that the closure part 3 is guided in a sliding manner on the closure part 2, engaging behind the edge portions 202, and thus moves relative to the closure part 2 with a form-fitting connection.

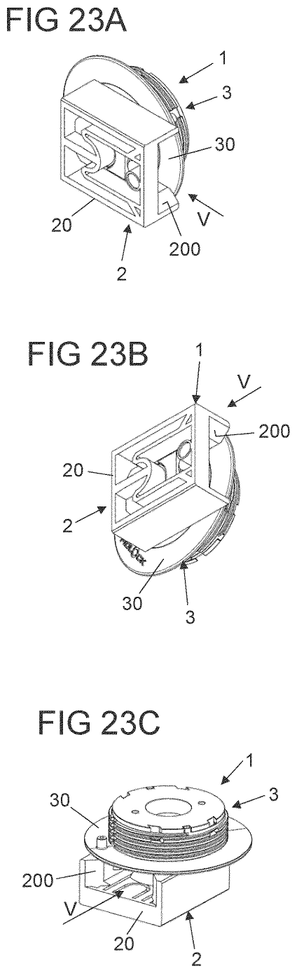

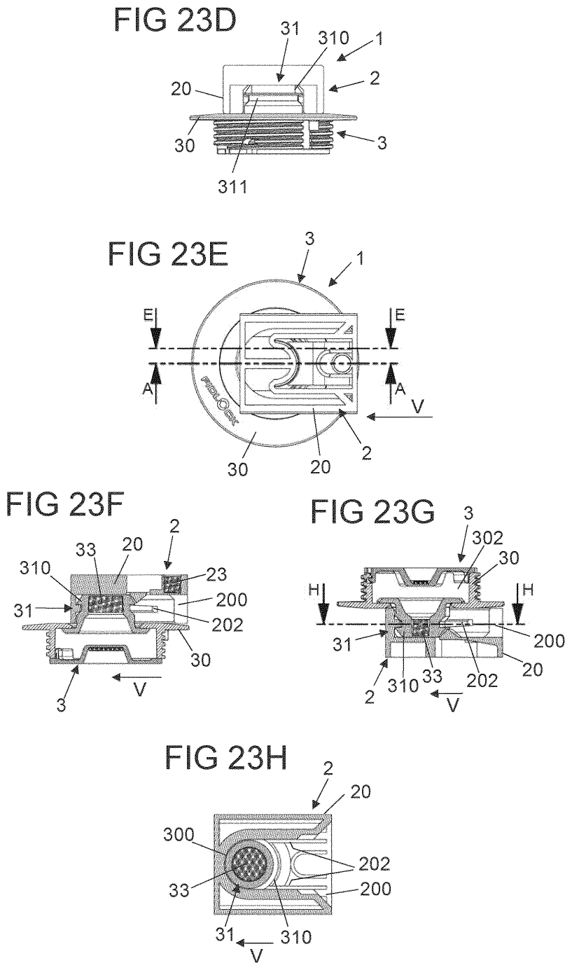

The holding position according to FIG. 23A to FIG. 23H is reached as soon as the engagement element 31 has reached an end position in the displacement portion 201, in which the head 310 of the engagement element 31 cannot be moved any further in the displacement direction V. The closure parts 2, 3 are thus connected and held together in a loadable manner.

In the embodiment shown, the first closure part 2 comprises a blocking element 22 which is formed by a blocking portion that projects into the region of the displacement portion 201 and protrudes from a bottom of the displacement portion 201, as can be seen for example from the exploded view according to FIG. 19B in overview with the sectional view according to FIG. 20F.

In this case, the blocking element 22 is formed on the housing part 20 in a resiliently deflectable manner, and is configured integrally and in one piece with the housing part 20.

The blocking element 22 comprises a run-on slope on both sides, onto which the engagement element 31 can run.

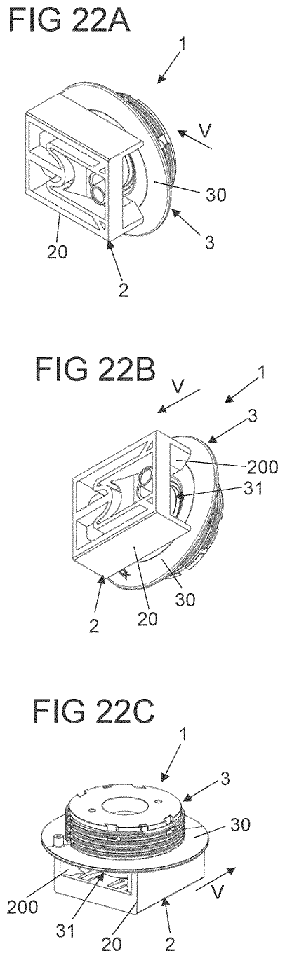

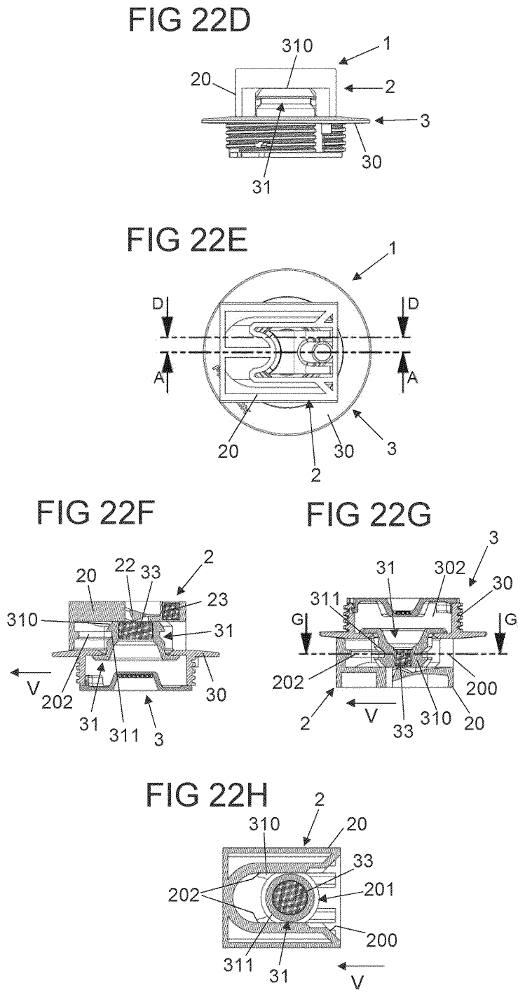

Thus, upon displacement in the displacement direction V for interconnecting the closure parts 2, 3, the engagement element 31 runs onto the blocking element 22 and pushes this resiliently aside, as can be seen from the sectional views according to FIGS. 22F and 22G. If the head 310 of the engagement element 31 has passed the blocking element 22, then the blocking element 22 snaps back into its relaxed initial position, such that the engagement element 31 is blocked and thus held in the displacement portion 201, in the holding position according to FIGS. 23A to 23H.

However, since in this case the blocking element 22 also comprises a run-on slope on the side facing the engagement element 31 in the holding position, counter to the displacement direction V, the holding apparatus 1 can be opened in the case of action of force on the closure part 3, counter to the displacement direction V, without the blocking element 22 needing to be actuated separately for this purpose. If the action of force on the engagement element 31 exceeds a predefined threshold force, which is determined by the shape of the run-on slope on the blocking element 22 and furthermore by the resilient properties of the blocking element 22, then the head 310 of the engagement element 31 runs onto the blocking element 22 and pushes this aside again, such that the engagement element 31 can be moved out of the displacement portion 201. The holding apparatus 1 can thus be opened without separate actuation of the blocking element 22, by action of force on the engagement element 31.

Otherwise, the embodiment according to FIGS. 19A, 19B to 23A-23H is functionally identical to the embodiment according to FIGS. 1-17, and therefore reference is made to the explanations above.

The concept on which the disclosure is based is not limited to the embodiments described above, but rather can also be implemented in other ways.

A holding apparatus of the type described can serve for connecting very different objects to a superordinate assembly. In this respect, the use of the holding apparatus for connecting a tool to a carrying device, for example a tool belt, is not limiting for the present disclosure.

In this case, the object can be rigidly connected to the engagement element or can be held on the engagement element via a holding element, for example in the form of a flexible band.

The holding apparatus according to the present disclosure can in particular serve as a toolholder, for example for holding a tool on a tool belt. In this case, the first closure part can for example be fixable on a belt, such that a tool can be arranged on the belt and connected to the belt via the holding apparatus.

The holding apparatus according to the present disclosure is intended to be easy to handle for a user, for example for holding a tool, and to establish a reliable connection of the object to the assembly in the holding position. A holding apparatus in particular for holding a tool should be easy and comfortable for a user to handle even in difficult conditions, for example when using the tool in an industrial application, for example on a construction site. An object, in particular a tool, is intended to be able to be easily and reliably connected to the associated assembly via the holding apparatus, to be held reliably and in a loadable manner on the assembly in the holding position, and furthermore to be easily and intuitively separable from the assembly again. In this case, the holding apparatus is intended to also be as insensitive as possible to contamination.

1. A holding apparatus for holding an object on an assembly, comprising
a first closure part which comprises an insertion opening and a displacement portion that adjoins the insertion opening and comprises two edge portions that extend along a displacement direction, and
a second closure part which comprises an engagement element having a head and a shank extending from the head, wherein in order to close the holding apparatus for holding the object on the assembly, the head of the engagement element can be inserted into the insertion opening of the first closure part and can be displaced along the displacement direction out of the region of the insertion opening into the displacement portion, such that in the case of a displacement the engagement element engages behind the edge portions with the head and extends with the shank through between the edge portions and slides along the edge portions until the engagement element reaches a holding position in which the first closure part and the second closure part are held against one another, wherein the first closure part and the second closure part can be separated from one another for removing the object from the assembly, wherein
the first closure part comprises a first magnet element and the second closure part comprises a second magnet element, wherein the first magnet element and the second magnet element interact in a magnetically attracting manner for assisting the insertion of the engagement element into the insertion opening, wherein the first closure part comprises a housing which is formed by at least one housing part, and a blocking element which is arranged displaceably on the housing and is intended for blocking the engagement element in the holding position.

2. The holding apparatus according to claim 1, wherein the engagement element can be inserted into the insertion opening along a closure direction, wherein the displacement direction is oriented transversely to the closure direction.

3. The holding apparatus according to claim 1, wherein the first magnet element is arranged in the region of the insertion opening, on the first closure part, and is configured for pulling the head of the engagement element into the insertion opening, for closing the holding apparatus.

4. The holding apparatus according to claim 1, wherein when the engagement element is inserted into the insertion opening the second magnet element is brought closer to the first magnet element, and when the engagement element is displaced into the displacement portion it is moved away from the first magnet element along the displacement direction.

5. The holding apparatus according to claim 1, wherein the head of the engagement element is configured to be rotationally symmetrical with respect to the closure direction.

6. The holding apparatus according to claim 5, wherein the second magnet element is arranged concentrically with respect to the axis of rotational symmetry of the head of the engagement element.

7. The holding apparatus according to claim 1, wherein the head of the engagement element is formed by a spherical head.

8. The holding apparatus according to claim 1, wherein the shank of the engagement element engages, in the holding position, through a slot formed between the edge portions.

9. The holding apparatus according to claim 1, wherein the second closure part comprises a base, wherein the shank is arranged on the base and carries the head on an end remote from the base.

10. The holding apparatus according to claim 9, wherein the engagement element is arranged displaceably on the base.

11. The holding apparatus according to claim 9, wherein in a retracted position the engagement element is received at least in part in a receiving opening of the base, and in an operating position can be moved out of the receiving opening by the head, wherein in the operating position the engagement element can be inserted into the insertion opening and pushed into the displacement portion.

12. The holding apparatus according to claim 1, wherein the blocking element is configured, in a blocking position, to block a movement of the engagement element counter to the displacement direction out of the displacement portion.

13. The holding apparatus according to claim 12, wherein at least one of:
the blocking element is preloaded in the direction of the blocking position relative to the housing;
the blocking element comprises a third magnet element which interacts in a magnetically attracting manner with the first magnet element, such that the blocking element is preloaded in the direction of the blocking position;
the blocking element can be moved out of the blocking position, upon displacement of the engagement element in the displacement portion in the displacement direction for moving the engagement element into the holding position, by interaction with the head or another portion of the second closure part; and
the blocking element comprises a blocking portion which projects into the region of the displacement portion, for blocking the engagement element in the blocking position, and therby blocks a movement of the engagement element out of the holding position counter to the displacement direction in the displacement portion.

14-16. (canceled)

17. The holding apparatus according to claim 1, wherein the blocking element is pivotably mounted on the housing of the first closure part.

18. The holding apparatus according to claim 1, wherein the blocking element comprises a handle for actuation by a user for unblocking the engagement element.

19. The holding apparatus according to claim 18, wherein the handle is arranged on a first side of the insertion opening with respect to the displacement direction, and the displacement portion is arranged on a second side of the insertion opening remote from the first side.

20. The holding apparatus according to claim 18, wherein the handle is to be actuated with an opening movement directed in the displacement direction, for unblocking the engagement element, and the engagement element is to be displaced counter to the displacement direction along the displacement portion for separating the first closure part and the second closure part from one another.

21. A carrying apparatus comprising a holding apparatus according to claim 1 for carrying a tool.

22. A carrying apparatus comprising a holding apparatus according to claim 1 for carrying an electrical or electronic appliance.

23. The carrying apparatus according to claim 22, wherein the electrical or electronic appliance is an electrical tool.
